(19) United States
(12) Patent Application Publication
(10) Pub. No.: US 2026/0276206 A1
(43) Pub. Date: Sep. 17, 2026

(54) ADAPTIVE COOKING METHOD AND APPARATUS

(71) Applicant: Raja Singh Tuli, Montreal (CA)

(72) Inventor: Raja Singh Tuli, Montreal (CA)

(21) Appl. No.: 19/559,869

(22) Filed: Mar. 6, 2026

Related U.S. Application Data
(60) Provisional application No. 63/769,837, filed on Mar. 11, 2025.

(51) Int. Cl. F24C 7/08; A23L 5/10; F24C 15/00

(52) U.S. Cl. CPC F24C 7/087; A23L 5/10; F24C 15/003; F24C 15/006

(57) ABSTRACT

The present invention provides an apparatus and a method for optimizing cooking processes through adaptive temperature control, real-time monitoring, and innovative design features. The methods dynamically adjust cooking temperatures based on food properties, such as size, shape, and density, using predictive algorithms and real-time feedback from infrared cameras and thermometers. Multi-stage cooking processes allow simultaneous preparation of meals with varied food groups, using temperature adjustments to ensure optimal doneness while preventing overcooking. A multi-zone cooking system creates temperature gradients within the cooking chamber, enabling precise and efficient preparation of foods requiring different heat levels. The apparatus features halogen lamps operating within a controlled wavelength range for precise searing and includes integrated cameras to analyze food properties and adjust heating parameters dynamically. Additional enhancements, such as angled fins for air circulation and high-powered fans, improve heat distribution, ensuring even cooking, reduced cooking times, and enhanced food quality.

### CROSS-REFERENCE TO RELATED APPLICATIONS

This application claims priority to U.S. provisional patent application No. 63/769,837, entitled “ADAPTIVE COOKING METHOD AND APPARATUS,” filed on Mar. 11, 2025. The content of this U.S. provisional patent application is hereby incorporated by reference in its entirety for all purposes.

### BACKGROUND OF THE INVENTION

### Field of the Invention

The present disclosure generally relates to the field of cooking foodstuffs such as meats and vegetables, in a faster, more efficient manner. More particularly, the invention relates to a method and apparatus for precision cooking of the foodstuff in controlled environment. The invention also relates to the technical field of cooking appliances, in particular to a steam oven control method and device, cooking equipment, steam cooking, and searing all-in-one machine.

### Description of Related Art

Intelligent household appliances, such as steaming and baking ovens, have made life more convenient by providing a range of facilities. However, these appliances often have different settings for different brands and models, making it difficult for users without experience to correctly set the heating mode, temperature, and time for a particular food material. Even those with some experience may find it challenging to adjust the settings for different types of food. To produce delicious meals, it is important for users to understand the various heating modes, temperatures, and times for their specific oven and the food they are cooking. However, this can be complicated, particularly for those with limited cooking experience. If the parameters are set incorrectly, it can result in undercooked or overcooked food that must be discarded, leading to wasted food and energy. Improperly cooked food can also be a safety hazard, as undercooked food may contain harmful bacteria while overcooked food may be burnt and potentially cause injury. It is important for users to carefully set the appropriate parameters and monitor the cooking process to ensure that their food is cooked safely and properly.

While some ovens claim to determine if the food is cooked properly, the determination is purely based on the outer surface of the food. This can lead to inaccurate judgment, resulting in a poor user experience. For example, the surface of the food may appear to be cooked, but the inner part may still be raw. This can be a safety hazard, as undercooked food may contain harmful bacteria, and it can also be frustrating for the user who may have to discard the food and start over. To ensure that food is cooked properly, it is important for the oven to be able to identify the food material, and accurately assess the internal temperature of the food while cooking, not just the surface.

There are some methods that use image recognition technology to identify the type of food material and automatically cook it. However, these methods are limited in that they only identify the food material and initiate cooking, resulting in a poor automatic cooking experience for the user. To improve the automatic cooking experience, it would be helpful for the oven to be able to not only identify the type of food, but also adjust the cooking parameters based on the specific characteristics of the food, such as its size, shape, and desired level of doneness. This would allow for more precise and personalized cooking, resulting in a better overall user experience.

In the past, methods and devices have used compressed air (both preheated and not) to achieve browning and surface texture on cooked meat and have tried to control the relative humidity within an oven or pressure vessel. However, these known pressure cooking processes that use high-pressure steam tend to produce meat that looks and tastes boiled rather than roasted. This can be undesirable for those who prefer the taste and appearance of roasted meat. To achieve a roasted flavor and texture, it may be necessary to use additional cooking methods or techniques once high-pressure steam cooking step is complete.

Another problem with using high-pressure steam for cooking foodstuff is that it can lead to overcooking easily, particularly for thin cuts of meat like fish and chicken. In a restaurant setting, it is possible to sear the meat quickly using a very hot oven, which conserves energy and reduces cooking time. However, this is not always possible at home, where cuts of meat may be thinner and more delicate. As a result, it can be difficult to achieve the desired balance of juicy and crisp when cooking meat at home. To achieve a perfectly cooked piece of meat that is juicy on the inside and crisp on the outside, it may be necessary to control the time of the cooking steps better suited to the type and thickness of the foodstuff being cooked.

Additionally, cooking food items like chicken in the oven often leads to overcooking the exterior while waiting for the center to reach the safe temperature of 63° C., as the oven typically operates at higher temperatures, causing uneven cooking. Sous vide solves this by cooking the chicken at a precise, consistent temperature, ensuring the entire piece reaches 63° C. without overcooking. However, sous vide takes a long time, making it less efficient for quick meals. Both methods have drawbacks: oven cooking risks dryness and uneven results, while sous vide, though precise, is time-consuming.

There is accordingly a need for an improved cooking apparatus and cooking process by providing more precise and evenly distributed heat, as well as better control over the cooking environment.

It is therefore an object of the present invention to provide a cooking apparatus for cooking foodstuffs such as meats and vegetables, in a faster, more efficient manner. Further, the invention relates to a method and apparatus for cooking the foodstuff in a pressurized steam oven cavity with the foodstuff being steam cooked in stages. The invention can improve the cooking process by providing more precise and evenly distributed heat, as well as better control over the cooking environment. It may also be more energy efficient and easier to use compared to traditional cooking methods.

### SUMMARY OF THE INVENTION

The following summary is provided to introduce a selection of concepts in a simplified form that are further described below in the detailed description. This summary is not intended to identify key features or essential features of the claimed subject matter, nor is it intended to be used to limit the scope of the claimed subject matter.

The invention relates to cooking foodstuffs such as meats and vegetables, in a faster, more efficient manner. More particularly, the invention relates to a method and apparatus for cooking the foodstuff in a steam cooked in a stepped manner. The purpose of the present invention is to provide a faster and more efficient method of cooking food items while maintaining high product yield. Additionally, the invention can help in cooking and browning food items evenly in a single cycle.

In one embodiment of the invention, a cooking method optimizes the cooking times and ensures even cooking by dynamically adjusting the temperature of a cooking apparatus based on the physical properties of the food, such as size, shape, and density. The method employs a predictive approach to calculate the timing for reducing the cooking temperature, ensuring that the outer layer of the food item, typically 1-2 millimeters thick, reaches the target internal temperature without overcooking. Initially, the cooking apparatus is set at a higher temperature (e.g., 73-75° C.) to accelerate heat penetration through the outer layer, with the temperature subsequently lowered to the target level (e.g., 63° C.) as monitored by an infrared camera or thermometer. In some embodiments, a 3D measurement system captures images of the food to determine its size, further enhancing the precision of the cooking process.

In another embodiment of the invention, a method optimizes low-temperature cooking through an initial application of higher heat to expedite the process, followed by a controlled temperature reduction based on real-time monitoring. An infrared camera continuously captures temperature data from the food's surface, allowing the system to analyze the rate of temperature increase. This predictive approach enables the cooking apparatus to adjust the temperature precisely as the food surface nears the target temperature, preventing overshooting and overcooking. The system accounts for variables such as food size, density, and composition, ensuring accurate heat penetration and even cooking. By leveraging real-time feedback from the infrared camera, the method enhances control and consistency in the cooking process.

In another embodiment, a method for cooking food in a multi-phase reverse sear cooking process is disclosed. The process begins by scanning the food item using a dual-camera system to create a 3D representation, allowing the AI module to determine optimal cooking conditions. An initial high-temperature searing phase rapidly heats the food's surface to trigger the Maillard reaction, enhancing flavor and texture. The system then transitions to a low-temperature cooking phase, where heat is gradually reduced to cook the food evenly while maintaining moisture. Finally, a second high-temperature searing phase further enhances the crust, with real-time adjustments based on the food's shape and temperature data to ensure precision and consistency.

In another embodiment, a method for cooking a complete meal consisting of multiple food items in a single cooking apparatus, such as an oven, using a multi-stage cooking process is disclosed. The method enables food items from different food groups, such as vegetables and proteins, to be cooked simultaneously to their optimal degree of doneness. In the first stage, vegetables are cooked at a high temperature (e.g., 83° C.-85° C.) to soften, enhance flavor, and preserve texture and color without overcooking. In the second stage, the cooking temperature is reduced (e.g., 45° C.-74° C.), and the user is prompted to add protein to the oven. During this stage, vegetables enter a holding phase to avoid overcooking, while the protein cooks evenly, retaining its moisture and tenderness. Optionally, a third stage involves increasing the temperature again to sear the food, creating a caramelized exterior for enhanced flavor and texture. The process includes guidance prompts to ensure proper timing for adding ingredients and transitioning between stages, allowing varied ingredients requiring different cooking approaches to be ready simultaneously.

Another method for cooking multiple food items simultaneously in a single cooking apparatus by creating multiple cooking zones with different temperatures is disclosed. A temperature gradient is established within the cooking chamber, enabling distinct zones where different types of food can cook at their optimal temperatures. For instance, the central part of the oven may maintain a lower temperature for proteins requiring slow cooking, while the bottom part may sustain a higher temperature for vegetables that need quicker, high-heat cooking. This differential heating is achieved using a high-powered fan that accelerates heat loss in specific areas, directing cooler air to the central zone and retaining hotter air in the lower zone. The method ensures precise temperature regulation in each zone, preventing uneven cooking and allowing foods from different groups to be prepared simultaneously, enhancing efficiency and convenience in meal preparation.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 is a perspective front view of an example cooking apparatus in accordance with the subject disclosure.

FIG. 2 illustrates a flow diagram of the cooking process in accordance with the subject disclosure.

FIG. 3 illustrates a flow diagram of the cooking process in accordance with another embodiment of the invention.

FIG. 4 illustrates an example networked system of a cooking apparatus according to some embodiments of the invention.

### DETAILED DESCRIPTION

The subject disclosure is directed to cooking foodstuffs such as meats and vegetables, in a faster, more efficient manner. More particularly, the invention relates to a method and apparatus for cooking the foodstuff in a pressurized steam oven with the foodstuff being steam cooked in the first stage and seared in the next stage.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

References to an “app”, an “application”, and a “software application” shall refer to a computer program or group of programs designed for end users. The terms shall encompass standalone applications, thin client applications, thick client applications, web-based applications, such as a browser, and other similar applications.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

In the preferred embodiment of the invention, the foodstuff comprises foods items such as meat (e.g., bacon, pork chops, sausage, hamburger patties), poultry (e.g., whole turkey, chicken breasts or wings), seafood, vegetables (e.g., French fries, peppers), convenience or snack foods (e.g., burritos), pizza, breads, cookies, and pastries. It should be understood to one having ordinary skill in the art that foodstuff can comprise any variations of the above-mentioned food items marinated or lathered in oil or other substances.

The critical temperature of a food item can be defined as the precise internal temperature at which the food reaches optimal safety, texture, and flavor characteristics. This temperature varies depending on the type of food and its composition. For instance, poultry, such as chicken, must reach 65° C. to eliminate harmful pathogens like Salmonella, ensuring food safety. Similarly, red meat, such as steak, achieves medium-rare doneness at 57° C., where muscle proteins coagulate while retaining moisture. Starch-rich vegetables, such as carrots and potatoes, require 85° C. for proper gelatinization, ensuring a soft texture.

Reverse searing is a two-step cooking technique that involves cooking a foodstuff slowly at a low temperature in the first step, and then searing it at a high temperature for a short period of time at the end of the cooking process in the second step. The result is a piece of foodstuff that is evenly cooked throughout and has a delicious, caramelized sear on the outside. However, the problem with the conventional reverse sear method of cooking foodstuff is that a user needs to take out the food from the oven and check the food item with a thermometer to measure the internal temperature while it is being slowly cooked at the first step. It is not easy for a person cooking the food to understand exactly when to stop the slow cook and start searing the food so that it is not overcooked. The foodstuff may not develop a proper sear or crust if the initial low temperature cooking is not done evenly or accurately. Foodstuff may be overcooked if the internal temperature reaches the critical temperature before foodstuff goes into the fast cooking or searing stage. Additionally, convection based methods heat the foodstuff from outside using high temperatures until the foodstuff is cooked from the inside. This may cause the juices in the foodstuff to evaporate and the foodstuff to become dry. So, it is important to monitor the cooking process closely and to adjust the temperature and cooking time as needed to ensure that the foodstuff is cooked to the desired level of doneness, i.e. juicy on the inside and crispy on the outside.

In the reverse-sear cooking process, a food item must be uniformly heated to its core, ensuring that the internal temperature reaches a predetermined target temperature appropriate for the type of food being cooked. For instance, poultry, such as chicken and turkey, must reach an internal temperature of 63° C., root vegetables, such as carrots, typically soften at around 85° C., steak should be cooked to 57° C. for medium-rare, 63° C. for medium, and 71° C. for well-done, pork should be cooked to 63° C. with a three-minute rest, while fish should reach 63° C. for optimal doneness. Traditionally, this process is executed using a convection oven, steam oven, or sous vide device, with the internal temperature monitored via a probe thermometer, infrared sensor, or a calculated estimation of the time required to achieve the target temperature. However, conventional methods maintain the food at a fixed target temperature throughout the cooking process, leading to prolonged cooking durations.

According to a preferred embodiment of the invention, the disclosed cooking method provides an improved reverse-sear cooking technique that reduces cooking time by initiating the cooking process at a temperature higher than the target internal temperature of the food item. For example, if a food item is initially at room or refrigerated temperature, the cooking process may commence at 75° C. or higher for a predetermined duration before gradually lowering the cooking temperature as the surface temperature approaches the target internal temperature (e.g., 63° C. for poultry). The surface temperature of the food item can be monitored using a thermometer, an infrared camera, or a time-based thermal calculation. Additionally, the surrounding air temperature within the cooking chamber may be regulated to slightly exceed the target temperature to optimize heat transfer efficiency. Once both the surface temperature of the food item and the ambient air temperature stabilize near the target temperature, the food is maintained at this condition until the internal temperature at the core reaches the desired level. The internal temperature of the food item can be determined using a computed 3D profile of the food item, incorporating parameters such as size, shape, and type. Alternatively, direct temperature measurements may be obtained using a thermometer or an infrared camera. Upon completion of the initial slow-cooking phase, the food item undergoes a high-temperature searing process at approximately 275° C. for a short duration, such as a few minutes, to develop a caramelized crust while preserving internal juiciness. In an alternate embodiment, the method may employ a forward-searing process, wherein the food item is first seared at high temperature before transitioning to a controlled slow-cook phase.

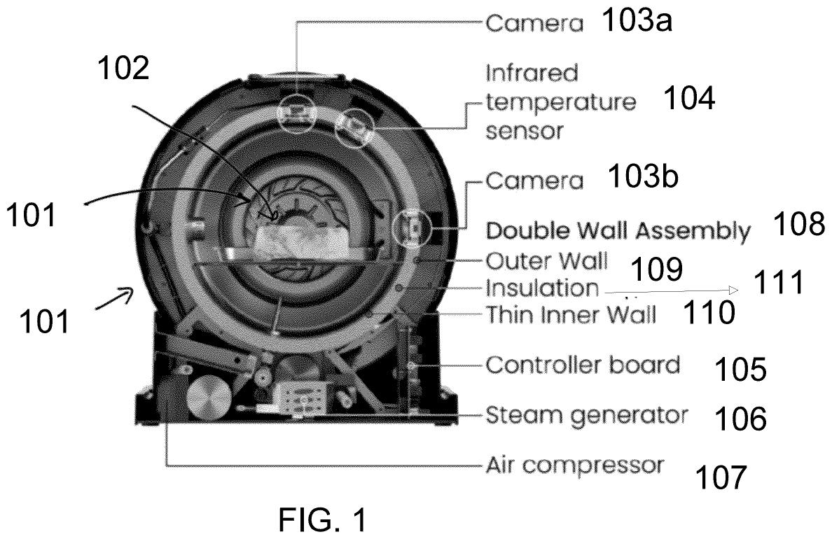

In FIG. 1, a cooking apparatus 100 is disclosed, configured to perform an automated reverse-sear cooking process. The present disclosure relates to a cooking apparatus 100 configured to perform pressure cooking, slow cooking, and high-temperature searing within a single cooking cycle. The cooking apparatus 100 includes a cooking chamber 101 designed to receive a food item 102.

A dual-camera system 103, comprising a first camera 103a and a second camera 103b, is configured to scan the food item 102 and generate a three-dimensional (3D) representation of its shape. An artificial intelligence (AI) system integrated within the cooking apparatus 100 analyzes the 3D representation to identify the type of food item 102. Additionally, an infrared temperature sensor 104 is configured to measure the initial temperature of the food item 102. Using the collected data, a control board 105 determines and sets precise cooking parameters, including cooking temperature and cooking duration to optimize the cooking process.

According to an embodiment of the invention, pressurized steam or hot air can be injected into the cooking apparatus 100 by a steam generator 106 and an air compressor 107 respectively. In a preferred embodiment of the invention, when the water is pumped from a tank into a steam generator, the steam is generated by the steam generator 106 outside of the chamber 101 and pumped inside the chamber 101 allowing to inject the steam at different temperatures based on requirements. In some embodiments, even very low temperature steam like moist air can be injected into the chamber. The built-in air compressor 107 delivers fresh pressurized air directly into the oven. Both steam generator 106 and an air compressor 107 create an ideal cooking environment. In some embodiments, a temperature and humidity sensor can measure the temperature and humidity of the steam and provides the readings to the steam generator. In this way, the steam generator regulates and helps in generating the steam and air mix with an appropriate temperature and humidity. The generated steam is injected into the cooking chamber through an inlet. It should be understood that in some embodiments of the invention, the cooking chamber 101 can comprise a pressure sensor to monitor the pressure inside the chamber and a humidity sensor to monitor the humidity inside the chamber.

Upon completion of an initial cooking phase, the cooking apparatus 100 transitions to a high-temperature searing phase. During this phase, the temperature within the cooking chamber 101 is rapidly increased to approximately 275° C. within seconds. The duration of the searing phase is dynamically adjusted based on the 3D shape of the food item 102 to prevent overcooking or drying while achieving a Maillard reaction on the surface.

According to a preferred embodiment, the cooking chamber 101 and its lid feature a double-walled construction, consisting of an outer wall 109 and a thin inner wall 110. The thin interior wall 110 of the cooking chamber 101 enables the cooking apparatus to reach searing temperature quickly. As illustrated in FIG. 1, insulation 111 is positioned between the outer wall 109 and the inner wall 110 to enhance thermal efficiency and maintain a stable cooking environment.

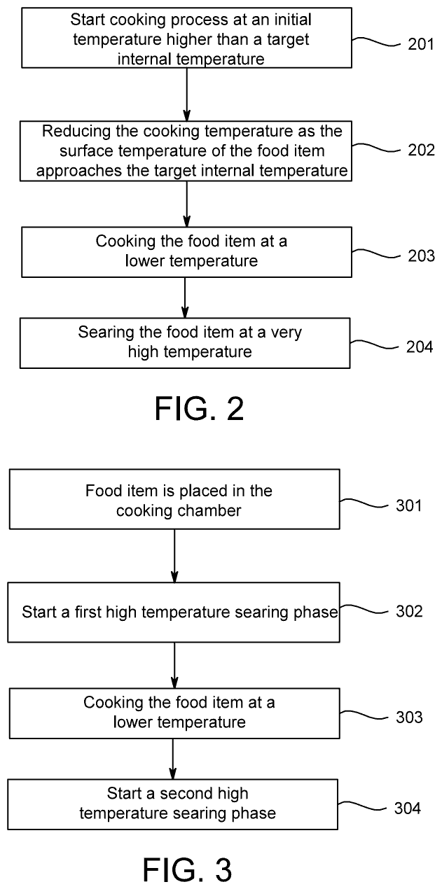

FIG. 2 illustrates a method of cooking a food item in the cooking apparatus 100 using a stepped approach according to the preferred embodiment of the invention. The method enables cooking a food item precisely to a target temperature. In a preferred embodiment, the method provides a low-temperature cooking process by integrating the benefits of high-temperature searing with the precision of slow cooking.

The process begins at step 201 by cooking the food item at a relatively high initial temperature as compared to the target temperature of the food item. It should be understood that the target cooking temperature varies depending on the type of food item being cooked, and accordingly, the initial cooking temperature is adjusted. Additionally, cooking the food item at an initial high temperature can quickly start the cooking process and also promotes flavor development on the surface of the food item.

In a subsequent step 202, as the surface temperature of the food item approaches the target cooking temperature, the process gradually lowers the cooking apparatus's heat output, to transition into a low-temperature phase that slows down cooking to prevent overcooking. As the cooking process progresses, the cooking temperature is reduced incrementally once the surface temperature of the food approaches the desired target temperature. The gradual reduction in the cooking temperature minimizes overcooking and preserves the moisture and tenderness of the food. In a preferred embodiment of the invention, the timing of the temperature reduction is calculated based on the physical properties of the food item. The physical properties may include but not limited to type, size, shape, and density of the food. The physical properties of the food item further influence the time for heat to reach the center of the food item. In one embodiment, the method can predict the time for surface temperature of the food item to reach the target internal temperature by using these physical properties.

In one embodiment, the process includes real-time monitoring of the food's external temperature. In example embodiments, the cooking system continuously tracks the temperature of the food's surface using infrared camera(s) or thermometer(s), and adjusts the cooking temperature precisely, ensuring that the surface temperature does not exceed the target threshold, preserving the moisture, texture, and integrity of the food item.

At step 203, the method determines the required cooking duration for the food item 102 at the temperature near its target cooking temperature and subsequently start cooking the food item for the identified time period. In some embodiments, a predictive approach can be used to precisely determine the time for this near target temperature cooking phase. The method can determine the time necessary for the internal temperature (i.e., temperature of the core of the food item) to reach to the target cooking temperature of the said food item. Additionally, the physical properties of the food item, such as size, shape, density, and thermal conductivity, influence the time required for the center of the food item to reach the target temperature.

At step 204, the method transitions to a second cooking cycle, after the food item 102 has been cooked to the target internal temperature for a predefined duration during the first cooking cycle. In this step, the food item 102 is subjected to a high-temperature searing phase for a significantly shorter predefined duration. This searing phase enhances surface caramelization and texture while preserving the juiciness of the interior.

In an example embodiment, to cook the food faster, the initial cooking temperature of the cooking apparatus can be set higher, for example, 75 degrees centigrade, than the target cooking temperature, for example, 63 degrees centigrade. The temperature of the outside layer of the food is continuously monitored using a thermometer or an infrared camera. As the temperature of the outside layer (1~2 mm) of the food item, such as chicken, reaches between 63 to 65 degrees, the cooking temperature of the oven is reduced to 63 degrees using an automated cooking process. After cooking the food at 63 degrees for a predefined period of time in the first cooking cycle, the food is seared in the next cooking cycle at a very high temperature of 275 degrees for a couple of minutes. Generally, the initial temperature of the food items is less than the room temperature. The method of cooking the food item initially at a relatively high temperature may enable 1~2 millimetres of the food to heat faster and subsequently help the inside of the food to cook faster through conduction. Since it is challenging to pass the heat through the outer layer of the food item, the initial cooking temperature for a food item is selected such that the outside temperature of the food item does not increase substantially above 63 degrees.

In another example embodiment, while cooking a food item taken from the refrigerator (around 4 degrees Celsius) at a normal cooking temperature may take a longer time to cook. The initial cooking temperature of the cooking apparatus can be set at 75 degrees till 1~2 millimetres of the outer layer of the food item (chicken) reaches 65 degrees, and then the temperature of the oven can be reduced to 65 degrees or 63 degrees. Alternatively, the initial cooking temperature of the cooking apparatus can be set at 75 degrees till 1~2 millimetres of the outer layer of the food item (chicken) reaches 63 degrees, and cooking temperature of the oven is set at 63 degrees for further cooking. The proposed method provides faster cooking as compared to traditional methods without overcooking the food items.

In some embodiments, the disclosed cooking method comprises a multi-phase process in which a plurality of slow-cooking phases and high-temperature searing phases are executed in a sequential manner or in any predetermined or dynamically determined order. The process is initiated at an elevated cooking temperature to accelerate the initial cooking reaction, after which the temperature is progressively adjusted across multiple phases. In particular, the cooking temperature is gradually reduced through one or more slow-cooking phases to facilitate uniform heat distribution and prevent overcooking, while intermittent high-temperature searing phases are introduced to enhance surface texture and flavor through the Maillard reaction. The transition between cooking phases is dynamically controlled based on real-time monitoring of the internal and surface temperatures of the food item, ensuring that the food reaches the desired target internal temperature while maintaining optimal moisture retention and texture.

In some embodiments, outer layer of the food can be cooked to a higher temperature than the target cooking temperature. It should be understood that the temperature of the outer layer should not be substantially higher than the target temperature, in order to avoid overcooking the internal layers of the food item. The method improves the speed of cooking without sacrificing the taste.

FIG. 3 illustrates a multi-phase reverse sear cooking process. The cooking process begins at step 301 when a food item 102 is placed inside the cooking chamber 101 of the cooking apparatus 100. The dual-camera system 103 scans the food item to create a three-dimensional (3D) shape representation. This data is processed by an artificial intelligence (AI) module to recognize the type and dimensions of the food item 102, allowing the control system 105 to determine the appropriate cooking parameters. The infrared temperature sensors 104 measure the initial surface and internal temperature of the food item 102 to establish baseline conditions.

At step 302, in the initial high-temperature searing phase, the cooking chamber 101 is rapidly heated using a high-intensity heating element, which may include infrared emitters, induction coils, or resistive heating elements. Thin interior walls 110 of the cooking chamber 101 helps the cooking apparatus 100 reach a searing temperature very quickly. The chamber temperature is increased to above 275° C. (527° F.) within seconds. The generated high heat sears the outer surface of the food item 102, triggering the Maillard reaction, which enhances flavor and develops a crust while keeping the internal temperature substantially below the fully cooked state. In some embodiments, the air compressor 107 may be used to direct a focused stream of heated air onto the surface, ensuring uniform searing. Additionally, the steam generator 106 can inject bursts of steam to modulate humidity and optimize the searing effect.

Upon completion of the initial searing phase, at step 303, the cooking apparatus transitions into the low-temperature cooking phase. The control system 105 dynamically lowers the temperature of the cooking chamber 101 by adjusting the power to the heating elements and activating an exhaust fan 114 to distribute heat evenly. The double-walled construction of the chamber 101 and lid, helps maintain a stable temperature while reducing heat loss. The cooking temperature is gradually lowered until it reaches a controlled level suitable for slow cooking. During this phase, the food item 102 is cooked at a precisely regulated temperature until the internal temperature reaches the target level appropriate for its type. For example, poultry may be cooked until it reaches 63° C. (145° F.), while steak for medium-rare doneness may reach 57° C. (135° F.). The air compressor 107 is used to moderate air circulation, preventing excessive drying of the food item, while the steam generator 106 can introduce moisture if necessary to enhance juiciness. The control module continuously monitors temperature data from the infrared sensors 104 and adjusts heating cycles accordingly.

After the slow-cooking phase, the apparatus transitions into the final high-temperature searing phase. At step 304, the heating system 112 is reactivated to rapidly increase the temperature of the cooking chamber 101 to a high searing level. This second sear is designed to develop a thicker Maillard reaction layer, enhancing both flavor and texture. The duration of this phase is dynamically controlled based on the 3D shape data collected by the dual-camera system 103 to prevent over-searing and ensure an evenly cooked exterior. The air compressor 107 may be used to direct heated airflow onto the surface, ensuring an even sear. In an alternate embodiment of the invention, there can be one or more slow cook and one or more searing cooking phases in a single cooking cycle.

Once the final searing phase is complete, the cooking apparatus 100 may enter a resting or hold phase, where the heating elements 112 are deactivated, and a cooling fan 114 gently lowers the chamber temperature. This prevents overcooking due to residual heat and allows the juices within the food item 102 to redistribute, ensuring a tender interior with a crisp exterior. The cooking apparatus 100 provides a fully automated, dynamically adjustable cooking process, ensuring that the food item 102 undergoes a multi-phase reverse sear to achieve an optimal balance of flavor, texture, and moisture retention.

In a preferred embodiment, the temperature of the food item being cooked in the cooking apparatus 100 can be monitored using an infrared camera 104 provided inside the cooking chamber 101. The infrared camera can measure the temperature of the outer layer of the food item (chicken skin, for example) being cooked. In an alternate embodiment, a thermometer can be inserted into the food item to measure the temperature of the food item being cooked in the cooking apparatus. The cooking apparatus can intelligently calculate the time for the outer layer (2 millimetres, for example) of the food item to reach a certain target temperature based on the initial temperature of the food item, size of the food item etc. Furthermore, this time can be used as a parameter to reduce the cooking temperature to the target cooking temperature and cook the food item.

In some embodiments, a 3D measurement system, including but not limited to a 3D camera, in the cooking apparatus is configured to capture images of the foodstuff in the cooking apparatus. In one embodiment, the 3D measurement system is integrated into an oven. The user may place the food item in the oven, and the 3D measurement system can automatically capture images of the foodstuff and determine the actual size of the food items. In a preferred embodiment of the invention, the 3D measurement system captures an image of the foodstuff and determines the size before the cooking process is started.

In another embodiment, the cooking method provides a process to optimize low-temperature cooking by initially applying a higher heat to jump-start the cooking process, followed by a controlled reduction in temperature. The food being cooked is continuously monitored using an infrared camera. The infrared camera captures real-time temperature data of food surface. The real-time temperature data can be used to determine the rate at which the food surface temperature increases. By analyzing the rate of temperature increase, the cooking system can predict when the food surface is close to reaching the desired target temperature. The cooking apparatus then reduces the cooking temperature based on the rate of temperature increase to avoid overcooking.

This predictive approach ensures that the temperature adjustment happens at the ideal moment, thereby preventing overshooting and allowing for more precise control over the cooking process. The infrared camera provides accurate feedback on the temperature trajectory, allowing the system to account for factors such as food size, density, and composition, which all influence heat penetration and retention.

In some embodiments, the disclosed method may allow larger cuts of meat or denser foods to cook evenly without compromising the tenderness of the interior or creating a dry outer layer. The initial high temperature cooking can develop a desirable crust or sear on the outside, enhancing the flavor profile, while the gradual temperature reduction allows for even heat penetration to the center of the food item. The method shortens the overall cooking time compared to traditional low-temperature cooking by accelerating the initial cooking stage, and quickly heating the outer surface of the food item to the target temperature.

Disclosed is a method for cooking a meal consisting of one or more food items in a cooking apparatus such as an oven. The method provides a multi-stage cooking process that enables cooking the one or more food items in a single cooking session. In a preferred embodiment of the invention, the method allows food items belonging to different food groups such as vegetables and meats (or proteins) to be cooked together in a single apparatus simultaneously in a way that the food items are cooked to a desirable degree of doneness. In a first cooking stage, the method enables cooking a first food group (for example, vegetables) at a high temperature for a first period of time. In a second cooking stage, the method enables reducing the cooking temperature to a second cooking temperature, introducing the second food group (for example, meat) into the cooking chamber and cooking the food items at the second cooking temperature for a second period of time. In an example embodiment, the method allows preparation of a complete meal in a single oven session, such that vegetables and proteins are cooked to perfection and ready at the same time. In this example embodiment, the cooking process may begin by placing vegetables in the cooking chamber and cooking the vegetables at a high temperature (for example, 83° C.-85° C.) for a few minutes. This initial high-temperature cooking stage may enable the vegetables to soften and develop flavor, retaining their texture and color without becoming mushy or overdone. In the next stage, the cooking process may lower the cooking temperature (for example, to a range of 45° C.-74° C.) to prepare for cooking the protein. The cooking process may prompt the user to open the oven and place the protein in the cooking chamber. The cooking process may then resume cooking the food items at the lower cooking temperature for a period of time. In this stage, vegetables and proteins cook together, however because of the lower temperature, vegetables are not cooked a rapid rate and are preserved in a holding stage, avoiding overcooking. The protein is cooked evenly and retains moisture.

In another embedment, the cooking process includes a third, high temperature cooking stage. The third stage allows the food items to be cooked (for example, seared) at a high temperature for a third period of time. In a preferred embodiment, the third cooking stage may be used to give the food items a caramelized exterior.

In example embodiments of the multi-stage cooking process, a cooking program may provide guidance and prompts to the user, indicating when to open the cooking apparatus to add the protein and initiate the second cooking phase. The multi-stage cooking process can be used to cook meals comprising varied ingredients that require different cooking approaches but need to be ready simultaneously.

In another embodiment of the disclosed invention, a method is provided for cooking one or more food items in a cooking apparatus. The method enables creation of one or more cooking zones in the cooking apparatus such that the one or more cooking zones cook food at different temperatures at the same time. In a preferred embodiment of the disclosed invention, the method creates a temperature gradient in the cooking apparatus that allows varied amounts of heat to be distributed in different cooking zones. For example, the cooking apparatus may allow a lower cooking temperature to be maintained in the central part of the cooking chamber (first cooking zone) and a higher cooking temperature to be maintained in the bottom part of the cooking chamber (second cooking zone). In this example embodiment, proteins such as meats (that require slow cooking at a lower temperature) can be cooked in the central part of the oven and vegetables (that require cooking at higher temperatures) can be cooked in the bottom part of the cooking chamber.

In some embodiments of the invention, the one or more cooking zones are created using a high-powered fan, which accelerates the rate of heat loss in certain parts of the oven. The fan-driven airflow may enable cooler air to circulate in the central part of the oven, and hotter air to circulate in the bottom part of the oven. This multi-zone, differential cooking method allows food items belonging to different food groups and requiring different cooking temperatures to cook simultaneously in a single oven session at their optimal cooking temperatures. The fan can regulate the temperatures and airflow in the different cooking zones to prevent uneven cooking, ensuring that each food type receives the right amount of heat in the right areas of the oven.

In one embodiment, the cooking apparatus may be cylindrical in shape and may comprise a blower or fan on back side of the apparatus. Additionally, the cooking apparats may comprise one or more fins inside the cooking chamber. For example, the cooking apparatus may comprise one or more fins placed at angles (e.g. 30 degrees to 45 degrees from the apparatus's centerline) along its length. In this embodiment, the fins may direct hot air inside the oven such that the hot air impinges on the food item placed in the cooking chamber. The fins may direct the hot air on the food item from the top of the cooking chamber and/or from the bottom of the cooking chamber. The disclosed arrangement of fins inside the cooking apparatus allows to direct more hot air on the food item being cooked in the cooking chamber.

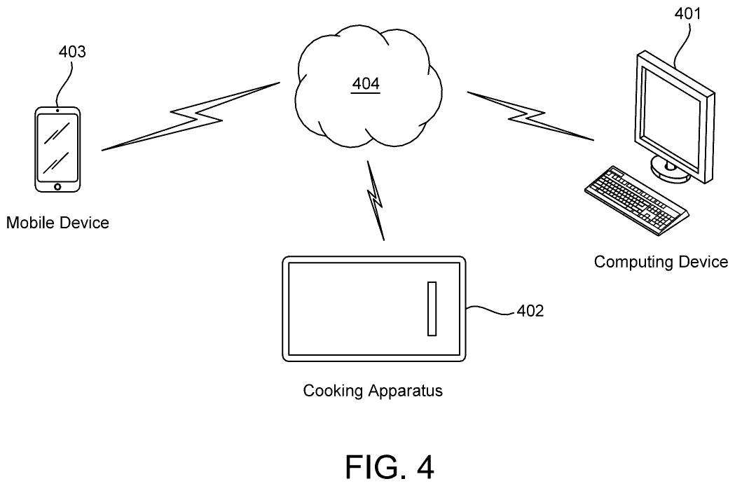

FIG. 4 is a networked system of a cooking apparatus, in accordance with various embodiments. A computing device 401 can store the food profiles of the foodstuff. The computing device 401 can be accessed via a wide area network (WAN) 404, such as the Internet. A cooking apparatus 402 can establish a network connection to the computing device 401. In some embodiments, a mobile device 403 can be connected to the cooking appliance 402 via a local area network or a peer-to-peer connection (e.g., Bluetooth) or an ad-hoc network. In some embodiments, the connection to the cooking apparatus 402 can be established by an access point, a router, the mobile device 403, or other network equipment known to a person of ordinary skilled in the art. It should also be noted that the system shown in FIG. 4, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

In some embodiments of the invention, a user can change the amount of sear through an application installed on their mobile device. The user can also change the temperature and duration of the sear to the desired crisp level. In other embodiments, the user can select the predefined settings from the application. Based on user selection, the method can change (increase or decrease) the amount of time for steam cooking and searing.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed. Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A method for cooking a food item, the method comprising:
initiating a first cooking phase by cooking the food item at an initial temperature higher than a target internal temperature of the food item;
monitoring a surface temperature of the food item;
progressively reducing the cooking temperature as the surface temperature of the food item approaches the target internal temperature;
maintaining the cooking temperature at a near-target temperature level until the core of the food item reaches the target internal temperature; and
transitioning to a second high-temperature searing phase for a predefined duration to sear the food item.

2. The method of claim 1, wherein temperature of the food item can be monitored using an infrared camera, a thermometer, or a combination thereof.

3. The method of claim 1, wherein temperature of the food item can be calculated using algorithm.

4. The method of claim 1, wherein the low temperature cooking period is determined based on one or more physical properties of the food item, including size, shape, density, and thermal conductivity.

5. The method of claim 1, wherein the high-temperature searing phase is performed at a temperature of at least 275° C.

6. The method of claim 1, further comprising a step of injecting pressurized steam or hot air into the cooking chamber during the first cooking phase to optimize heat distribution.

7. The method of claim 1, wherein the cooking apparatus dynamically adjusts between high and low temperatures using an artificial intelligence-based control system.

8. The method of claim 1, wherein the low-temperature cooking phase and the high-temperature searing phase can be performed in any order.

9. The method of claim 1, wherein the cooking apparatus comprises a double-walled construction with an insulation layer to maintain consistent thermal conditions.

10. A method for cooking a food item using a multi-phase reverse searing process, the method comprising:
initiating a first high-temperature searing phase by rapidly heating a cooking chamber to a searing temperature;
transitioning to a low-temperature cooking phase by dynamically reducing the cooking temperature;
monitoring and adjusting cooking parameters in real-time using temperature sensors, an air circulation system, and a steam injection system; and
initiating a second high-temperature searing phase after the internal temperature of the food item reaches a target temperature.

11. The method of claim 10, wherein the duration of the second searing phase is dynamically controlling based on the 3D shape data of the food item to prevent over-searing and ensure even cooking.

12. The method of claim 10, wherein the dual-camera system includes an infrared camera for thermal mapping of the food item's surface temperature distribution.

13. The method of claim 10, wherein an air compressor directs heated airflow onto the surface of the food item during the searing phases to ensure uniform caramelization.

14. The method of claim 10, wherein the cooking chamber has a double-walled construction with thermal insulation to maintain a stable cooking environment and minimize heat loss.

15. The method of claim 10, wherein the cooking chamber has a thin internal wall construction to rapidly increase the cooking temperature to reach the searing temperature.

16. The method of claim 10, wherein the second high-temperature searing phase is performed at a temperature between 275° C. and 350° C.

17. The method of claim 10, wherein the cooking process can include one or more alternating slow-cook and searing phases within a single cooking cycle.

18. A method for cooking a complete meal in an oven, the method comprising:
initiating cooking of a vegetable component at a first, higher temperature within a range of approximately 83° C. to 85° C.;
reducing the oven temperature after the vegetables have partially cooked;
notifying a user to insert a protein component into the oven when the temperature is reduced to a range of approximately 45° C. to 74° C., wherein the vegetables remain in the oven during this period without overcooking;
continuing to cook both the vegetable and protein components at the lower temperature until they are cooked to their respective desired doneness levels; and
searing the vegetable and protein components at a higher temperature in the oven to finish cooking, ensuring both components are ready at the same time.

19. A method for cooking a complete meal in an oven, the method comprising:
creating a temperature gradient within the oven to establish two distinct cooking zones:
a first zone in the center of the oven at a lower temperature, and
a second zone at the bottom of the oven at a higher temperature;
utilizing a high-powered fan to increase the rate of heat loss in the oven, such that the returning airflow circulating through the center zone is at a reduced temperature compared to the bottom zone;
placing a protein component in the center zone of the oven to cook at the lower temperature;
placing a vegetable component in the bottom zone of the oven to cook at the higher temperature;
maintaining the temperature gradient through continuous operation of the fan to ensure optimal cooking conditions for both the protein and vegetable components simultaneously.

20. A cylindrical cooking oven for evenly cooking food items, the oven comprising:
a fan positioned at the back of the oven, configured to circulate air within the cooking chamber; and
a series of fins or features positioned along the inner surfaces of the oven, including the top, bottom, and sides, wherein the fins are oriented at an angle of approximately 30 to 45 degrees from the centerline of the oven,
wherein, the fins configured to direct the circulating air to impinge on the food item and ensure controlled airflow patterns to optimize heat transfer and provide cooking efficiency.
